(19) United States
(12) Patent Application Publication
(10) Pub. No.: US 2003/0066238 A1
(43) Pub. Date: Apr. 10, 2003

(54) Plant cultivation apparatus and method for growing crops in sequence

(76) Inventor: Blake Whisenant, Parrish, FL (US)

Correspondence Address: LARSON & TAYLOR, PLC, 1199 NORTH FAIRFAX STREET, SUITE 900, ALEXANDRIA, VA, 22314, US

(21) Appl. No.: 09/969,882

(22) Filed: Oct. 4, 2001

(51) Int. Cl. A01G 25/00

(52) U.S. Cl. 47/79

(57) ABSTRACT

An apparatus and method for growing plants with controlled rates of nutrient and water input. The apparatus and method includes the use of a reservoir container and means to contain a growing medium. The apparatus is closed by a top wall having openings through which plants can grow with their roots enclosed in inverted cup-shaped barrier structures imbedded in a growing medium. At the time of the first planting there are multiple inverted cup-shaped barrier structures imbedded in the growing medium, but not all them are provided with seedlings during the first planting. Water and air is provided in a reservoir below the growing medium which has means for assisting the transfer of water from the reservoir into the growing medium. Pre-selected plant nutrients (e.g., N, K) are appropriately placed on the growing medium at the time of the initial planting and are used over the course of time for plant growth during successive plantings.

### FIELD OF THE INVENTION

The present invention relates to a plant cultivation method and apparatus and, more particularly, it relates to a water-efficient and labor-efficient method and apparatus for growing multiple crops of various fruits and vegetables in sequence from a single preparation of the growing medium and plant nutrients.

### BACKGROUND

In the cultivation of various plant species, numerous structures for housing a growing medium have been proposed to enable the grower to control the quantity of water supplied to the roots of the plant as well as to maintain the integrity of the growing medium. In general, these prior art structures have involved a container for the growing medium and other nutrients together with an irrigation system for supplying water.

In U.S. Pat. No. 5,524,387 to Blake Whisenant, entitled “Plant Cultivation Apparatus and Method,” incorporated herein by reference, there is disclosed a reservoir container assembly for the cultivation of plants. The reservoir container in the Whisenant '387 patent comprises a single reservoir container which may be made of solid materials such as recycled plastic. The reservoir container assembly includes a growing medium volume defined by the reservoir container which is separated from a drain volume along its lower wall by a permeable partition situated in a spaced relationship above the lower wall. In use, the growing medium volume is filled with a growing medium into which the roots of plants are grown. The reservoir container assembly of the Whisenant '387 patent has a top wall made of plastic material such as recycled plastic. The top wall has one or more openings therein for plant growth with the openings being positioned along the side of the top wall adjacent to the lateral wall.

In the apparatus disclosed in the Whisenant '387 patent, there is at least one drain opening in the lower area of the one of the lateral walls to allow excess water to flow out of the drain volume and thereby prevent the level of water in the drain volume from rising above the drain opening height. This ensures that the top portion of the drain volume will be filled with air and that the growing medium housed above the permeable partition has contact with air, such air being important for proper plant growth.

The apparatus of the Whisenant '387 patent also utilizes a column or columns of growing medium that extend into the drain volume at the lower portion of the assembly. The column(s) is filled with growth medium to allow the water in the drain volume to reach from the lower portion of the drain volume into the growing medium volume located above the permeable partition. In use, water will move up the growing medium column and into the growing medium volume by the process of capillary action. In addition, in the device disclosed in the Whisenant '387 patent, the column of growing medium is positioned so that it is adjacent to the lateral wall that is near to the plant opening in the top wall. The Whisenant '387 patent discloses that it is preferable that the columns of growing medium be positioned in the corners of the reservoir container but that they can be positioned anywhere along the lateral wall along which the plants are located. In the Whisenant '387 patent, the single reservoir container and its drain volume area is divided into compartments by rectangularly-shaped dividers which may be inter-connected with one another. The purpose of the dividers is to ensure that the permeable partition is positioned in the reservoir container so that the permeable partition lies parallel to the bottom wall and at a given height above the bottom wall thereby forming a drain volume for the water and air.

The device of the Whisenant '387 patent uses a gradient concept for the growing medium and nutrients. The gradient concept was initiated and evaluated during the 1960s as the nutritional component for a field-oriented, full-bed mulch system of production. The basic components are a soluble source of nitrogen (N) and potassium (K) on the soil bed surface in conjunction with a continuing water table. The N and K move by diffusion to the plant roots and equilibrate concurrently with the less soluble nutrients in the soil to maintain a predictable range of decreasing ionic concentrations with associated decreases in the ratio of N and K to total ions in the soil solution. The full-bed mulch minimizes the effect of evaporation and rainfall as physical forces that can alter the ionic composition of the soil solution. The total concept is designed to synchronize the rates of nutrients/water input with those of crop removal, and thus provide long term nutritional stability.

Nutrients in the soil move by diffusion, which is synchronized with removal or moved by mass flow with the water which is not synchronized with removal. By eliminating in-bed N—K (conventional procedure) and using on-bed N—K (gradient procedure), it is possible to maintain a continuing nutritional stability in the soil solution.

When conventional nutritional procedures are exposed to variations in the soil-plant-season combinations, nutritional stability in the soil solution can be weakened or destroyed. In the transition to more intensive production systems, conventional nutritional procedures often cannot maintain the nutritional stability required for continuing advances in productivity, whereas the gradient procedures sustain that stability.

In the prior art methods and apparatus including the methods and apparatus disclosed in the '387 patent, it is conventional to fill the reservoir container assembly with growing medium and to plant one or more plants in an array at the top location of the assembly. For example, with plants that will produce large vines such as tomatoes, only two plant locations are selected after filling the device with a growing medium. In contrast, with smaller plants, such as green peppers, it is known to plant an array consisting of two lines of three plants aligned along the axis of the reservoir container. In either case, the entire reservoir container assembly is prepared with growing medium and fertilizer for the planting of the selected seedlings and they are grown to maturity and harvested at substantially the same time. Thereafter, after the plants are done with their production, they are removed from the reservoir container assembly and the assembly is again prepared for the planting and growth of a new set of plants.

In U.S. Pat. No. 5,103,584 to Blake Whisenant, incorporated herein by reference, there is disclosed a plant cultivation apparatus which includes an inverted structure to enclose a plant's roots during growing.

### SUMMARY OF THE INVENTION

While the reservoir container assembly of the Whisenant '387 patent is beneficial for the growing of single crops, in certain instances it has been found advantageous to make multiple seedling plantings from the same previously-prepared growing medium or growing medium and fertilizer combination. More particularly, one object of the present invention is to provide an improved reservoir container assembly which permits multiple cropping from a plant cultivation apparatus of the type disclosed in the Whisenant '387 patent.

A further object of the present invention is to provide an improved method of plant growth by providing an apparatus and method which permits the sequential planting of seedlings without interference or disturbance of an initially-prepared growing medium and fertilizer.

A further object of the present invention is to provide an improved apparatus and method of plant growth for use in large commercial scale plant growth operations which are more efficient and less labor intensive than those involved in the prior art. More particularly, it is an object of the present invention to provide an improved method and apparatus for plant growth which permits more than one crop to be grown based upon one series of preparation operations. More specifically, the same growing medium or growing medium and fertilizer combination are used for at least a second crop without the requirement that the growing medium and/or fertilizer need any further significant labor input beyond the initial preparation of the reservoir container assembly. The improved method and apparatus provide greater flexibility because of improved plant size options and improved options for the placement of the plants in either of successive crops.

### BRIEF DESCRIPTION OF THE DRAWINGS

Numerous other objects and the advantages of the present invention will become apparent from the consideration of the following disclosure taken in conjunction with the drawings, in which:

FIG. 1 is a side view with portions broken away of one embodiment of a reservoir container assembly prepared according to the present invention;

FIG. 2 is a cross-sectional view taken along the line 2-2 of the reservoir container assembly of FIG. 1;

FIG. 3 is a top plan view of the reservoir container assembly of FIG. 1 with portions broken away;

FIG. 4 is a side view with portions broken away of another embodiment of a reservoir container assembly according to the present invention;

FIG. 5 is a cross-sectional view taken along the line 5-5 of the reservoir container assembly of FIG. 4;

FIG. 6 is a top plan view of the reservoir container assembly of FIG. 4 with portions broken away;

FIGS. 7A to 7D are diagramatic top plan views of several examples of sequential crop plantings according to the present invention.

### DETAILED DESCRIPTION OF THE PREFERRED EMBODIMENTS

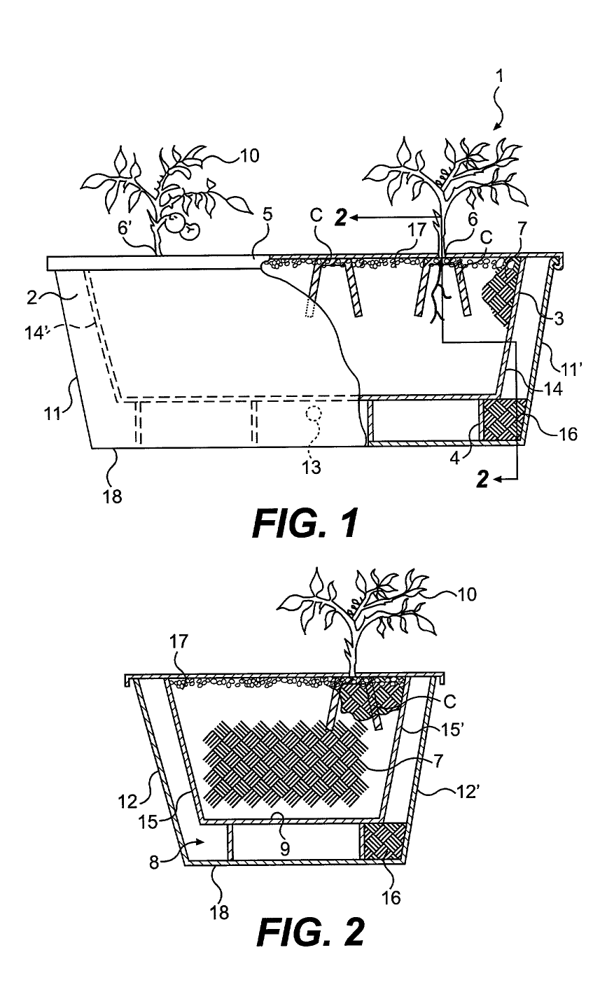

As show in FIG. 1 the reservoir container assembly 1 according to one embodiment of the present invention comprises a reservoir container or box 2, a basket-style growing medium container 3 nested within the reservoir container 2 and resting upon divider 4. The reservoir container is closed by a top wall 5 having openings 6 and 6′ through which one or more plants can grow with their roots embedded in the growing medium 7 contained within the basket-type growing medium container 3. As best seen in FIGS. 1 and 2, the roots embedded in growing medium 7 are surrounded by an inverted cup-shaped barrier structure C which will be described in more detail below. As used in this specification and claims, the phrase “means for confining the roots of plants” refers to the inverted cup-shaped barrier structures as well as their equivalents which include, among other things, cylinders and rectangular boxes with or without a planar upper face.

The reservoir container may be made of solid material such as recycled plastic. The growing medium volume defined within the basket-style growing medium container 3 is separated from drain volume 8 by a permeable bottom wall partition 9 of the basket-style container 3. The basket-style container 3 may be made of material such as recycled plastic and have side and end walls 14-14′ and 15-15′. As an alternative (not shown), the end walls 14-14′ may be eliminated and the side walls 15-15′ extended to the length of the reservoir container or box 2. The growing medium volume contained within the basket-style container 3 is filled with a growing medium such as a potting mixture in which the plants 10 are grown.

The top wall 5 of the reservoir container 2 may be made of solid material such as recycled plastic. Alternatively, it can be of a flexible plastic sheet with a peripheral edge attached to the upper end of the reservoir container or box 2. The reservoir container 2 has two end walls 11, 11′ and two lateral walls 12 and 12′. Top wall 5 has plant openings 6 and 6′ therein for plant growth, said plant opening(s) being positioned at various places depending upon the type and size of plants being grown as discussed in more detail below. As best seen in FIG. 1, the reservoir container has at least one opening 13 in one of the lateral walls 12, 12′ to allow excess water to flow out of the drain volume 8 and thereby prevent the level of water within the drain volume 8 from accumulating above the opening 13. This ensures that the top portion of the drain volume 8 will be filled with air and that the growing medium 7 thereabove has contact with air along the bottom 9 and side and/or end walls 14-14′, 15-15′ of the basket-style container. Of course, such air is important for proper plant growth.

Growing medium column(s) 16 in drain volume 8 allows the water in said drain volume to reach from the lower portion in said drain volume into the growing medium 7. Water will move up the growing medium column(s) 16, then into the growing medium 7 by the process of capillary action. As best seen in FIGS. 1 and 2, growing medium column(s) 16 are positioned so that they are adjacent the bottom wall of the basket-style container 3 at locations which are advantageous for the growing of the particular type of plant as described in more detail below.

FIG. 2 generally shows a layer of fertilizer mixture 17 which is placed on top of the growing medium at the top of the growing medium volume defined by the basket-style container 3. Using the above gradient-oriented nutritional procedures, the fertilizer 17 is placed in an appropriate location depending upon the type of plant being grown, the numbers of plants being grown and the location of the growing medium column(s) with respect to the plant opening(s) in the top wall 5.

The positioning of plant openings 6 and 6′, growing medium column 16, and fertilizer mixture 17 preferably causes the salt deposits to occur remote from the roots of the plant 10. The positioning of these elements ensures that the water passing next to the plant 10 has not previously passed through fertilizer 17. Capillary action causes the water in drain volume 8 to flow up the growing medium column(s) 16 and through the growing medium volume to plant openings 6 and 6′. There will thus be flow paths leading from the growing medium column(s) 16, one path to opening 6 and another path to opening 6′.

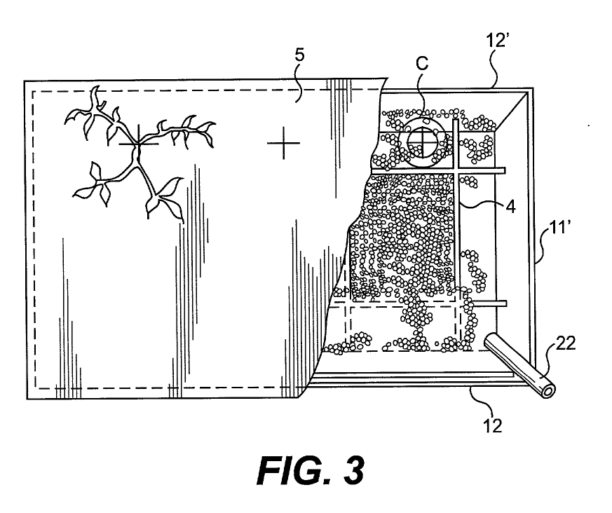

As best seen in FIG. 3, the drain volume 8 is divided into rectangular compartments by dividers 4. These dividers may be rectangularly-shaped and may be positioned so as to be approximately perpendicular to the top wall 5 and the bottom wall 18 of the reservoir container. The dividers ensure that the basket-style container 3, and its permeable bottom partition 9, is positioned in the reservoir container 2 so that the permeable partition 9 lies parallel to the bottom wall 18 of the reservoir container and at a given height above the bottom wall 18, thereby forming a drain volume.

For further details of the construction of the basket-style growing medium container, reference is made to co-pending application Ser. No. 08/812,572, filed Mar. 6, 1997, which is incorporated herein by reference.

Further, as best seen diagrammatically in FIGS. 2 and 3 the fertilizer mixture 17 is placed on the growing medium 7 contained within the basket-style growing medium container 3 at locations selected to be appropriate for a given combination of growing medium column(s) 16 and the type, size and number of plants being grown. As seen in FIG. 3, a water-fill tube 22 may be provided so that water can be passed into the upper end of tube 22 and fed to the lower portion of drain volume 8.

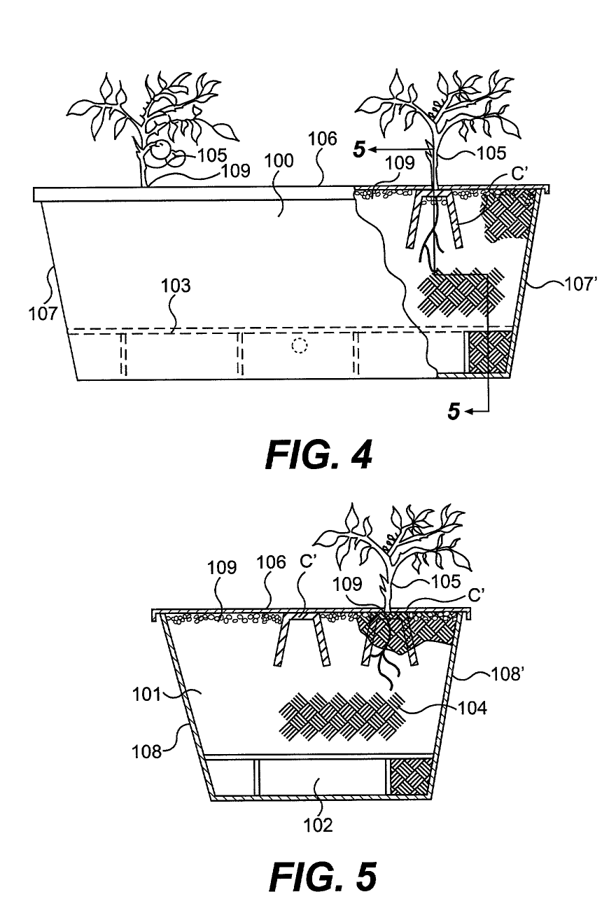

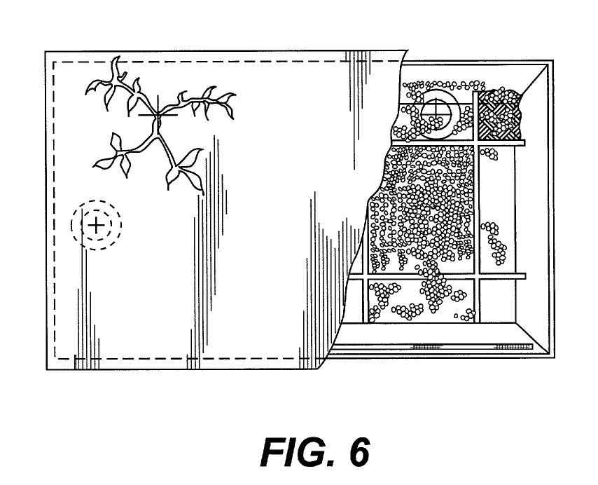

FIGS. 4, 5 and 6 relate to a second embodiment of the reservoir container assembly of the present invention. As shown in FIG. 4, this embodiment is comprised primarily of a single reservoir container or box 100. The container may be made of a solid material such as recycled plastic. Growing medium volume 101 in reservoir container 100 is separated from drain volume 102 by a permeable partition 103 which may be plastic or rust-proof metal screen. Growing medium volume 101 is filled with a growing medium 104 such as described above in which plants 105 are grown. Top wall 106 of reservoir container 100 may be made of solid or flexible sheet material such as recycled plastic. Reservoir container or box 100 has two end walls 107-107′ and two lateral walls 108 and 108′. Top wall 106 has openings 109 therein for plant growth, said plant openings being positioned over a cup-shaped barrier structure C′. As best seen in FIG. 5, cup-shaped barrier structure(s) C′ are embedded in the growing medium 104 and are adjacent a layer of fertilizer mixture 109.

Further details of this embodiment of the reservoir container assembly are shown in U.S. Pat. No. 5,524,387, which is incorporated herein by reference.

The following is a description of the apparatus and method of the present invention in use.

Plant Selection

Some gardeners prefer starting with seedlings or plant starts in their growing container. Healthy looking plants should be selected. A local nursery or county extension agency can recommend varieties that are best suited to the user's area.

Location and Assembly

The user should choose a location for the reservoir container assembly which will receive plenty of sunlight. The growing container assembly can also be indoors if there is enough light. The divider should be in the bottom of the reservoir container with the medium container or the growing medium resting on top of it. Insert the fill tube 22 as seen in FIG. 3 and use a cable or other fastener to fasten it to the upper corner of the reservoir container. The fill tube 22 should be in the front of the reservoir container on the same side as drain hole 13 as seen in FIG. 1. The user should be sure that the fill tube 22 goes from the top of the reservoir container into the water reservoir drain volume 8 as seen in FIG. 2.

Potting Mixture

2.3 cubic feet (about 30 pounds or 60 dry quarts) of a light and spongy soil-less potting mixture is suitable for potting and use as a growing medium. Many brands are readily available at any garden center or home store. While the exact composition is not important, most mixes contain about 60% of peat moss plus composted wood products, perlite, vermiculite, and minor elements. Many gardeners mix one cup of dolomite to the potting mix. Soil-based potting soil is too dense and is not recommended for home use. A good potting mix will last for several growing seasons.

Stakes and Tomato Cages

Tomatoes, eggplant, pole beans, and other vine plants will need four-foot support stakes. They can be installed at the ends of the growing container and secured to the end walls 11-11′ by appropriate fasteners (e.g., ties through openings in the walls). Twine can be tied between the stakes to support the plants as they grow. Tomato cages can also be installed after the plants begin to mature. Smaller vegetable and flower plants do not need stakes.

Filling the Growing Container

The user should fill the bottom of the growing container with water until it runs out the drain hole 13. Openings have been cut in the permeable bottom of the basket-style container, exposing the water in the bottom of the reservoir container. Firmly pack these two openings with moist potting mix. Now cover the permeable bottom with potting mix and fill the basket half way up. Pack the soil down and moisten it well with water. Now completely fill the rest of the basket with potting mix and make a slight crown on top similar to a cupcake. Use plenty of potting mix so that a lip is not left between the top of the growing container and the top of the potting mix. Add water on top to make sure the potting mix is moist and refill the reservoir container using the fill tube. In the case of using a growing container assembly without the interior basket-style container, the process is similar only the potting mix is used to completely fill the container above the permeable partition 103 situated above the water drain volume 102.

Use of Dry Fertilizer

The growing container assembly differs from conventional gardens in that fertilizer is added at the beginning. Any general purpose dry granular fertilizer, such as 666, 888, 6-8-10, or organic mixtures can be used. After the growing container has been filled with potting mix, multiple inverted cup-shaped barrier structures C are inserted into the potting mix so that their truncated tops are level with the top of the potting mix. Thereafter, dry fertilizer 17 is added to the top layer of the potting mix, in some cases across the entire top surface of the growing container assembly. Sufficient fertilizer should be provided at this point to fertilize not only the initial crop, but also at least part of the second or later crop(s) to be planted as described below.

Covering and Planting

After the potting mix and fertilizer have been applied, completely cover the top of the growing container with one of the plastic top sheets and secure it over the outside edges of the reservoir with clips, clothes pins or the like. Poke the top end of the water fill tube 22 through the cover. Place the white side of the cover up in warmer climates and the black side up in cooler climates. Cut four inch holes or “Xs” in the plastic top sheet, spaced from the outside wall of the growing container. Plant the seedlings through the “Xs” into the potting mix contained within the inverted cup-shaped barrier structures and “water them in” just as in conventional gardening. The plastic top sheet may remain on the growing container assembly for the life of the plants and functions as a mulch, among other things.

Watering

Plants are watered by simply adding water through the tube 22 to fill the bottom water drain volume. You cannot over water with the growing container assembly because of the use of a drain hole 13. The growing container assembly automatically provides the proper amount of moisture. For example, when plants are small one only needs to add water every few days. As the plants grow larger, they will require more water. It may be desirable to add water regularly until it runs out the drain hole 13 indicating that the reservoir is full. Rain will not water the roots of the plants because they are covered by the plastic top sheet and by the upper surface of the truncated, cup-shaped barrier structure as described above.

Harvesting

Depending upon the type of plant, the output is harvested and the initial growing crop is terminated. Thereafter, instead of uncovering the growing medium and removing the roots of the plants from the first crop, those are simply left in place and the process of cutting “Xs” into the additional inverted cup-shaped structures is repeated much the same as the above initial planting. Thereafter, watering and growth for those additional plants of the second planting is carried just as above.

In view of the above, it can be seen that significant economies in a labor-intensive situation can be obtained. Thus, whereas the prior method and structure required a complete replanting and refertilization of the growing medium before planting the second crop in any given container, with the present invention, that additional labor is eliminated because the second crop is planted into the previously-prepared growing medium and fertilizer combination. Thus, significant labor-saving advantages are present, especially in the case where the growing containers are utilized in a commercial setting where many hundreds of growing containers are prepared and used to grow a first crop and then a second crop according to the above-described procedure.

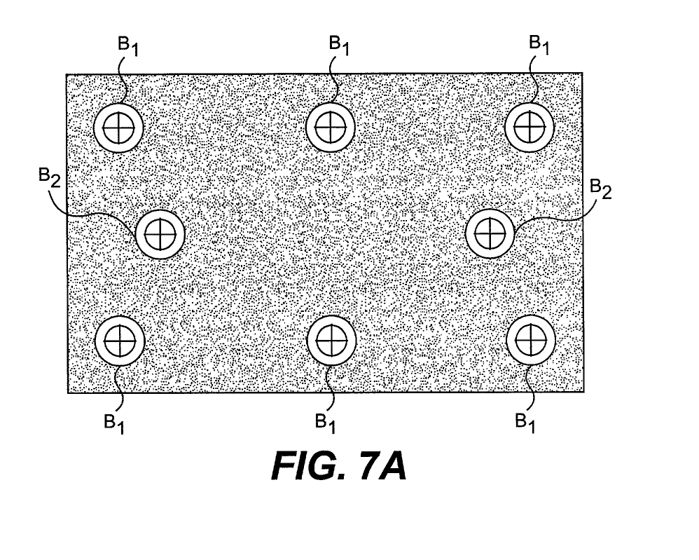

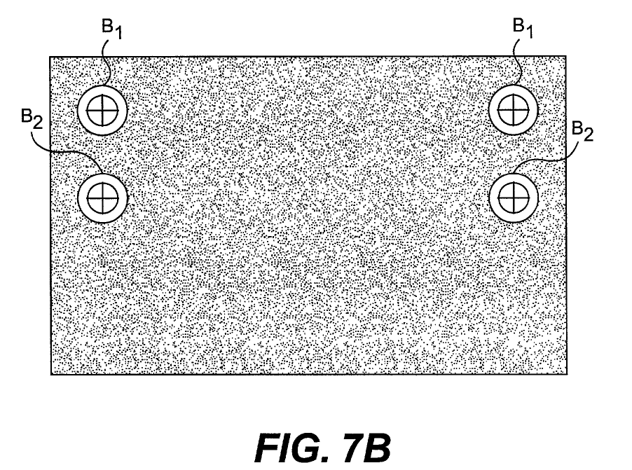

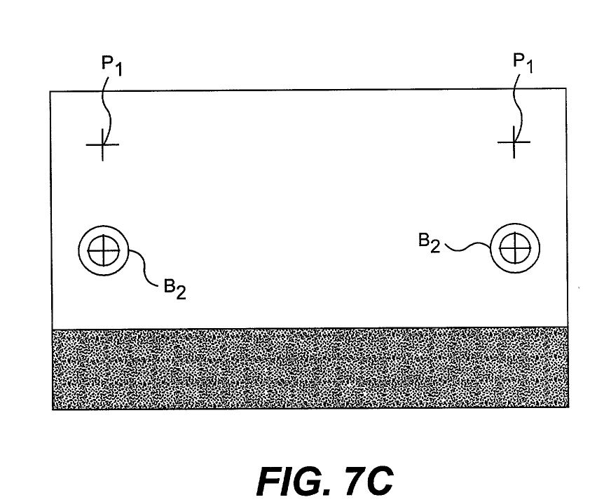

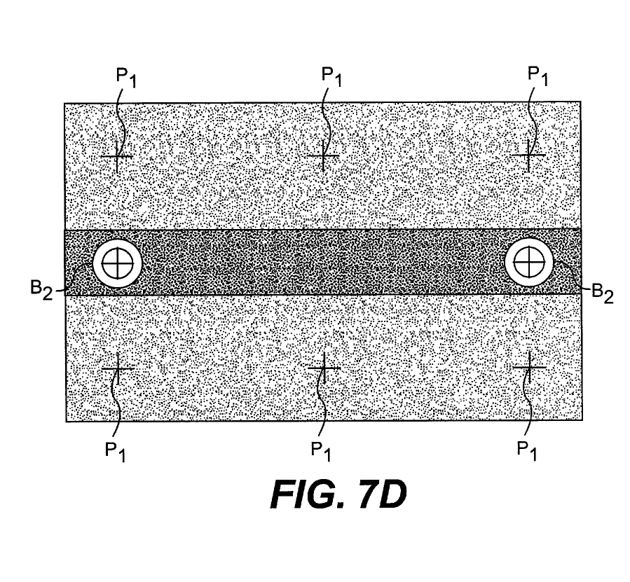

The following examples are given with reference to the top views of schematic drawings of FIGS. 7A to 7D.

### EXAMPLE 1

In FIG. 7A, cabbage plants were set in barrier cups B1. Fertilizer was applied over the entire top of the growing medium at twice the rate for a single crop. The fertilizer was 6-8-10 and the growing medium, commercially available from Speedling Corp., was Canadian peat moss and vermiculate. The cabbage was harvested and the plants were cut off at the barrier cup. Tomato plants were then set in barrier cups B2 which had been positioned in the center of the box at the time the growing medium and fertilizer were prepared prior to planting the cabbage plants. No new fertilizer was added; however, a new plastic top was added. The cabbage crop was normal and the tomato harvest was comparable to control boxes.

### EXAMPLE 2

In FIG. 7B, two tomato crops were grown consecutively. The first crop was set in barrier cups B1 and the second crop was set in barrier cup B2. Twice the fertilizer was applied over the entire top prior to setting the first crop. The first crop was in the fall and the second crop in the spring. Both crops were considered normal in both yield and growth. The first growing had a larger growing than the second. This is believed to be more from weather factors than from nutritional factors.

### EXAMPLE 3

In FIG. 7C, two tomato plants P1 and P2 were set in the conventional manner. No barrier cups were used and the fertilizer was placed in a band in the conventional manner. Barrier cups B2 were set in the center of the box where squash seed will be planted for the second crop. No additional fertilizer is to be applied prior to the second crop and the squash will use the residual fertilizer. The barrier cup provides excellent germination for the squash seed.

### EXAMPLE 4

In FIG. 7D, cabbage P1 was planted without a barrier cup. Fertilizer was banded along the center axis of the box. Barrier cups B2 were also placed in the center of the box. Tomatoes were planted in the barrier cups B2 after the cabbage was harvested. In this configuration, additional fertilizer was added over the entire top of box with a new plastic top being used after the first crop was harvested. The results were considered to be excellent. The tomatoes grew and compared favorably with control boxes. Cabbages were cut after harvesting and all roots were left in place.

It will be apparent to those skilled in this art that various modifications may be made thereto without departing from the spirit and scope of the invention as defined in the following claims.

What is claimed is:

1. A reservoir container assembly for growing plants, comprising: a container for holding water and a plant growing medium, a means for assisting the transfer of water from the bottom of said container to said plant growing medium, said container having a top wall portion which in use faces substantially upward and an opening in said top-wall portion for allowing plant growth therethrough, and at least two inverted cup-shaped barrier structures imbedded in the upper portion of the plant growing medium and adapted for containing the roots of seedlings and plants as they mature.

2. A reservoir container assembly for growing plants, comprising: a reservoir container, having a bottom, side, and end walls and an open top, the open top being disposed upwardly when the reservoir container is in use; a divider means located adjacent to the bottom of said reservoir container for defining an upper surface spaced a distance from the surface of the bottom; a permeable sheet having perforations positioned on the divider means so that moisture and air from the drain volume defined by said divider structure and reservoir container, can pass into a plant growing medium located thereabove, a top wall on the open top with at least one plant opening for allowing plant growth therethrough, and at least two inverted cup-shaped structures positioned in the plant growing medium adjacent its upper surface.

3. The invention of claim 1 wherein said plant growing medium has a layer of fertilizer adjacent its upper surface.

4. The invention of claim 2 wherein said plant growing medium has a band of fertilizer near its upper surface.

5. The invention of claim 1 where said plant growing medium includes time release fertilizer pellets.

6. The invention of claim 2 wherein said plant growing medium includes time release fertilizer pellets.

7. The invention of claim 1 wherein the reservoir container assembly for growing plants comprises a first container for holding a liquid, a second container means, including a perforated basket, for holding a plant growing medium, a means for assisting the transfer of water from said first container to said medium, said first container having a top wall portion that, in use, faces substantially upwardly and an opening in said top wall portion for allowing plant growth therethrough.

8. An array of a multiplicity of reservoir container assemblies as claimed in claims 1 or 2.

9. The method of successively growing plants from seedlings comprising:
providing a reservoir container, having a bottom, side and end walls and an open top exposed upwardly,
placing a basket-style container within said reservoir container, said basket-style container having an open top and perforated side and bottom walls, and a means for assisting the transfer of water from said reservoir container to the interior of said basket-style container, said placing step including arrangement of the basket-style container so that the walls and bottom of the basket-style container are spaced inwardly from the walls and bottom of the said reservoir container,
filling in the interior of said basket-style container and said means of assisting transfer of water with a plant growing medium;
providing a source of fertilizer adjacent to the top surface of said growing medium at a location spaced from the location of the seedlings,
covering the top of the reservoir container and basket-style container with a plastic sheet,
cutting holes in said plastic sheet at the locations for the seedlings,
planting the seedlings through said holes into the growing medium,
positioning inverted cup-shaped structures immediately beneath the holes in the plastic sheet in the locations for the seedlings,
adding water to at least part of the space formed between the bottom of the reservoir container and the inwardly spaced bottom of said basket-style container, said watering step being repeated multiple times during the growing of said seedlings.

10. A method of successively growing plants from seedlings comprising:
providing a reservoir container,
filling the lower portion of said container with water,
providing a perforated partition spaced above the bottom of said container,
filling the interior of the container above said perforated partition with a plant growing medium,
inserting a plurality of means for confining the roots of plants into the upper portion of said growing medium,
providing a fertilizer on said growing medium,
covering the filled reservoir container with a cover sheet,
cutting holes in said sheet at selected locations above said means for confining the roots of plants for a first batch of seedlings,
planting said seedlings through said holes into the growing medium,
adding water to at least part of the space formed between the reservoir container and the inwardly spaced perforated bottom, said watering step being repeated multiple times during the growing of said seedlings,
harvesting the output of said first batch of seedlings,
removing the portion of the mature seedlings of said first batch above said cover sheet,
cutting holes in said cover sheet at the remaining locations for a second batch of seedlings above said means for confining the roots of plants,
planting said second batch of seedlings through said holes into the growing medium, and
adding water to at least part of the space formed between the reservoir container and the inwardly spaced perforated bottom, said watering step being repeated multiple times during the growing of said second batch of seedlings.

11. A commercial production method of growing plants including the step of forming an array of plural reservoir containers and performing the method of claim 9 or 10 on said array.

12. A reservoir container assembly for growing plants, comprising: a container for holding water and a plant growing medium, means for assisting the transfer of water from the bottom of said container to said plant growing medium, said container having a top wall portion which in use faces substantially upward and an opening in said top-wall portion for allowing plant growth therethrough, and at least two means for confining the roots of plants imbedded in the upper portion of the plant growing medium for confining the roots of plants as they mature.

13. A reservoir container assembly for growing plants, comprising: a reservoir container, having a bottom, side, and end walls and an open top, the open top being disposed upwardly when the reservoir container is in use; a divider means located adjacent at the bottom of said reservoir container for defining an upper surface spaced a distance from the surface of the bottom; a permeable sheet having perforations positioned on the divider means so that moisture and air from the drain volume defined by said divider structure and reservoir container, can pass into a plant growing medium located thereabove, a top wall on the open top with at least one plant opening for allowing plant growth therethrough, and at least two means for confining the roots of plants positioned in the plant growing medium adjacent its upper surface for confining the roots of plants as they mature.
